(19) United States
(12) Patent Application Publication
(10) Pub. No.: US 2024/0360580 A1
(43) Pub. Date: Oct. 31, 2024

(54) TEMPORARY PLATING MASK FOR METAL ETCHING

(71) Applicant: Illinois Tool Works Inc., Glenview, IL (US)

(72) Inventor: Paul Blair, Jonesboro, GA (US)

(21) Appl. No.: 18/643,598

(22) Filed: Apr. 23, 2024

Related U.S. Application Data
(60) Provisional application No. 63/461,724, filed on Apr. 25, 2023.

(51) Int. Cl. C25D 5/02; C25D 3/04; C25D 5/34

(52) U.S. Cl. CPC C25D 5/022; C25D 5/34; C25D 3/04

(57) ABSTRACT

Manufacturers, particularly manufacturers of parts for aerospace applications, may use a plating mask. Plating masks may be used to mask a metallic part during etching and plating. The present disclosure describes a temporary plating mask that may comprise a hydrocarbon resin and a styrene block copolymer. The temporary plating mask may further comprise a tackifier and other additives such as pigments, fillers, dyes, surfactants, or rheology modifiers.

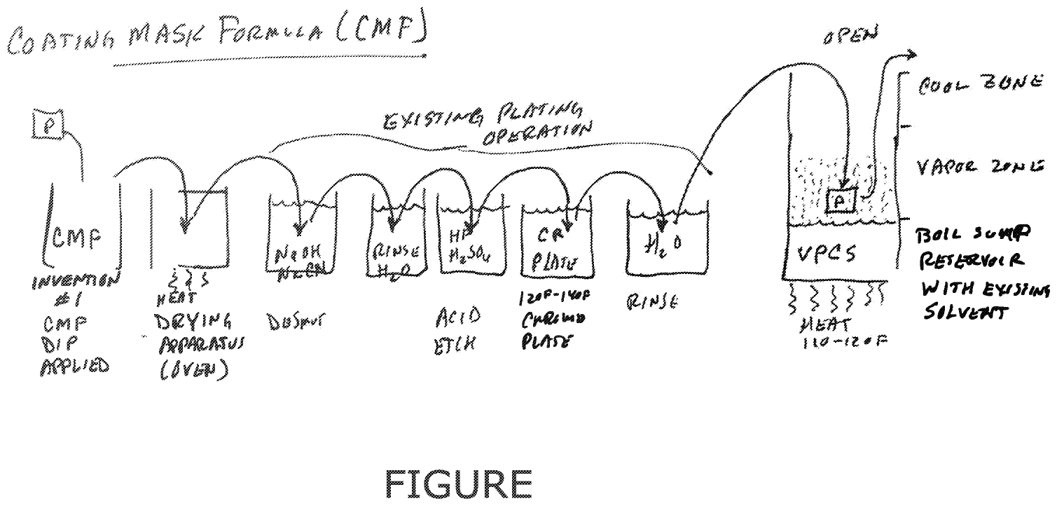

### CROSS-REFERENCE TO RELATED APPLICATIONS

This application claims benefit of priority to U.S. provisional patent application No. 63/461,724, entitled “Temporary plating mask for metal etching”, filed Apr. 25, 2023, the contents of which are herein incorporated by reference in their entirety.

### BACKGROUND

Manufacturers of parts for aerospace applications sometimes use a microcrystalline wax to mask parts when plating. The wax tolerates the harsh, hot plating baths. Currently, the primary method to remove the wax involves using vapor phase cleaners that contain perchloroethylene (“PERC”). There is a desire to replace PERC with different solvents. One limitation is that it there is a desire for the solvent to be both non-flammable and to boil above the melting point of the wax (typically, above 170 degrees F.), so that the vapor and condensate on the parts is above the melting point of the wax and the wax can be removed.

The wax may be removed in various steps, including first immersing the masked part in boiling water (which melts the bulk of the wax, which subsequently floats to the surface of the water). This is an incomplete process and subsequent processes are required. The last step in the process is vapor phase cleaning in PERC.

The masked part may also be re-immersed in a molten wax bath (210 to 230 degrees F.). If the part is left in the molten wax long enough, the part reaches the same temperature of the molten wax and the bulk of the wax melts off. Again here the last step is vapor phase cleaning in PERC.

### SUMMARY

According to an aspect of the present disclosure, a temporary plating mask may comprise a hydrocarbon resin and a styrene block copolymer. The temporary plating mask may further comprise a tackifier. The hydrocarbon resin may be a picco resin. The styrene block copolymer may comprise SBS, SIS, SIBS, SEPS, or SEBS.

According to another aspect of the present disclosure, a method for etching a metal substrate may comprise (a) applying a temporary plating mask to a metal substrate; (b) heat drying the metal substrate; (c) de-smutting the metal substrate in a caustic solution; (d) rinsing the metal substrate to remove the caustic solution from the surface of the metal substrate; (e) acid etching the metal substrate in an acidic solution; (f) rinsing the metal substrate to remove the acidic solution from the surface of the metal substrate; (g) chrome plating the metal substrate; and (h) removing the temporary plating mask.

### BRIEF DESCRIPTION OF DRAWINGS

The foregoing and other objects, features, and advantages of the devices, systems, and methods described herein will be apparent from the following description of particular examples thereof, as illustrated in the accompanying FIGURES; where like or similar reference numbers refer to like or similar structures. The FIGURES are not necessarily to scale, emphasis instead being placed upon illustrating the principles of the devices, systems, and methods described herein.

The FIGURE illustrates an example process for etching a metal substrate.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” “upper,” “lower,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

According to one aspect of the present disclosure, a masking wax is replaced by a temporary plating mask comprising a hydrocarbon resin and a styrene block copolymer. One advantage of this temporary plating mask is that it can be removed by solvents other than PERC. The temporary plating mask may be a clear, resinous coating. It may also comprise one or more “tackifiers” that enhance the tackiness of the temporary plating mask.

As shown in the attached FIGURE, a plating sequence for chrome plating for aerospace applications may involve (a) applying a temporary plating mask according to the present disclosure to a metal substrate; (b) heat drying the masked metal substrate (e.g., in an oven); (c) de-smutting in a strong caustic solution (e.g., NaOH and NaCN) at ambient temperature; (d) rinsing in water at ambient temperature; (e) acid etching (e.g., with a solution containing HCl, HF, or H₂SO₄) at ambient temperature; (f) rinsing in water at ambient temperature; (g) chrome plating batch at 140 F to 160 F for between 1 hour and 23 hours; and (h) removing the temporary plating mask (e.g., by using a suitable solvent at a temperature above the melting point of the temporary plating mask). The temporary plating mask must tolerate these conditions and protect the masked areas of the metal parts, typically landing gear and engine parts. The temporary plating mask must also tolerate nickel stripping baths and nickel plating baths that operate at temperatures between 120 F and 140 F. Other processes include cadmium and silver plating.

Electroless nickel plating, which is done between 175 F and 195 F, is especially challenging because micro-crystalline masking wax cannot tolerate those temperatures.

According to an aspect of the present disclosure, a temporary plating mask comprises two or more clear resins, dissolved in a solvent that allows for application to the parts to be plated. Each resin or resin type imparts specific desired properties.

### Hydrocarbon Resins (HCR)

Because the conditions are so chemically reactive the chemical coating must have little to no chemical reactivity-especially no polarity in the resin molecules. The base resins may be chosen from a class of aromatic, aliphatic and cycloaliphatic hydrocarbon resins called picco resins which offer different softening point temperature options from 75 to 120 degrees C. They are characterized by chemical inertness, excellent resistance to salts, acids, alkalis, water and brines, and it solubility in a wide variety of solvents, which make them ideal base resins for coating that must resist chemical assault, but be easily and quickly removed. The 120 degrees C. softening point picco resins appear to be too brittle but may be adapted to use with the high temperature electroless nickel baths in the future. The best balance on properties appear to be with a picco resin with a softening point of 98 degrees C. Picco resins may include Piccotex 75, Piccotex LC, Piccotex 100, Piccotex 120 or other C5 resins. Picco and aliphatic hydrocarbon resins (C5 Resins) are made from C5 piperylene and its derivatives, for example cis/trans 1,3-pentadienes, 2-methyl-2-butene, cyclopentene, cyclopentadiene, and dicyclopentadiene.

### Styrene Block Copolymers (SBC)

Stryene block copolymers may be combined with the picco resins to improve toughness and reduce the tendency of the picco resins to crack under physical or thermal stresses or when the coating is applied at thicker films. The styrene block copolymers may be chosen from SBS, SIS, SIBS, SEPS and SEBS. Other styrene block copolymers may include synthetic rubber compounds, such as styrene-butadiene-styrene rubber. Most are predominantly tri-block copolymers but di-block polymers may also be used.

### Tackifers

Tackifiers may also be included to improve adhesion at different temperatures or over a range of temperatures. Tackifiers may include hydrogenated hydrocarbon resins (hydrogenated C9), aliphatic hydrocarbon resins (C5), aromatic hydrocarbon resins (C9), or rosins resins.

The temporary plating mask may be applied by dip coating, spray coating or manually with brush or wipe. After application the wet coated parts will need to be dried either over time at ambient or an accelerated time with heat, between 60 and 100 degrees C.

Other modifiers, including an additive such as a pigment, filler, dye, surfactant, or rheology modifier, may be included in the temporary plating mask.

While the present method or system has been described with reference to certain implementations, it will be understood by those skilled in the art that various changes may be made and equivalents may be substituted without departing from the scope of the present method or system. In addition, many modifications may be made to adapt a particular situation or material to the teachings of the present disclosure without departing from its scope. For example, blocks or components of disclosed examples may be combined, divided, re-arranged, or otherwise modified. Therefore, the present method or system are not limited to the particular implementations disclosed. Instead, the present method or system will include all implementations falling within the scope of the appended claims, both literally and under the doctrine of equivalents.

What is claimed is:

1. A temporary plating mask comprising a hydrocarbon resin and a styrene block copolymer.

2. The temporary plating mask of claim 1, wherein the temporary plating mask further comprises a tackifier.

3. The temporary plating mask of claim 1, wherein the hydrocarbon resin is selected from the group comprising: picco resins.

4. The temporary plating mask of claim 1, wherein the styrene block copolymer is selected from the group comprising: SBS, SIS, SIBS, SEPS and SEBS.

5. The temporary plating mask of claim 1, wherein the temporary plating mask has a melting point of 100 degrees Fahrenheit or higher.

6. A method for etching a metal substrate comprising:
applying a temporary plating mask to a metal substrate;
heat drying the metal substrate;
de-smutting the metal substrate in a caustic solution;
rinsing the metal substrate to remove the caustic solution from the surface of the metal substrate;
acid etching the metal substrate in an acidic solution;
rinsing the metal substrate to remove the acidic solution from the surface of the metal substrate;
chrome plating the metal substrate; and
removing the temporary plating mask;
wherein the temporary plating mask comprises a hydrocarbon resin and a styrene block copolymer.

7. The method of claim 6, wherein the temporary plating mask further comprises a tackifier.

8. The method of claim 6, wherein the hydrocarbon resin is selected from the group comprising: picco resins.

9. The method of claim 6, wherein the styrene block copolymer is selected from the group comprising: SBS, SIS, SIBS, SEPS and SEBS.

10. The method of claim 6, wherein the temporary plating mask has a melting point of 100 degrees Fahrenheit or higher.
